(19) United States
(12) Patent Application Publication
(10) Pub. No.: US 2018/0104684 A1
(43) Pub. Date: Apr. 19, 2018

(54) AUTOMATED SAMPLE MIXING AND CENTRIFUGING APPARATUS

(71) Applicant: Centech Corp., Los Angeles, CA (US)

(72) Inventor: Omar Bennabi Kunbargi, Los Angeles, CA (US)

(73) Assignee: Centech Corp., Los Angeles, CA (US)

(21) Appl. No.: 15/785,420

(22) Filed: Oct. 16, 2017

Related U.S. Application Data
(60) Provisional application No. 62/408,794, filed on Oct. 16, 2016.

(51) Int. Cl. B01L 3/00; B04B 5/04; B01L 7/00

(52) U.S. Cl. CPC B01L 3/5021; B04B 5/02; B01L 7/52; B04B 5/0414

(57) ABSTRACT

An automated sample mixing and centrifuging apparatus capable of mixing the contents of one or more centrifuge sample tubes and then centrifuging the sample tubes in the same apparatus is disclosed herein. The apparatus comprises an electric slip ring, one or more mixing actuators, a device motor, and a rotor.

### CROSS-REFERENCE TO RELATED APPLICATIONS

This application claims priority to U.S. Provisional Patent Application Ser. No. 62/408,794, filed on Oct. 16, 2016, the disclosure of which is incorporated herein in its entirety by reference.

### BACKGROUND

### Field of the Invention

The present disclosure relates to a novel laboratory sample mixing and centrifuging apparatus.

### Description of the Related Art

A centrifuge is an apparatus that causes an object to rotate around a fixed axis, thereby applying a force perpendicular to the axis of spin. When the centrifuge operates, more dense particles and substances move radially outward on account of centripetal acceleration, and less dense particles and substances move radially inward. In a laboratory centrifuge that employs one or more sample tubes, radial acceleration causes denser particles to settle to the bottom of a given sample tube while lower density substances rise to the top of said sample tube.

In clinical and petroleum laboratories, samples must frequently undergo multiple process steps, such as a mixing step performed manually or using a mixer and a separate centrifugation step using a centrifuge. There remains a need for an apparatus that incorporates mixing and centrifugation steps into a single laboratory process.

### SUMMARY

An automated sample mixing and centrifuging apparatus capable of mixing the contents of one or more centrifuge sample tubes and then centrifuging the sample tubes in the same apparatus is disclosed herein. The apparatus comprises an electric slip ring, one or more mixing actuators, a device motor, and a rotor.

### BRIEF DESCRIPTION OF THE DRAWINGS

FIG. 1 illustrates an embodiment of the sample mixing and centrifuging apparatus described herein.

### DETAILED DESCRIPTION OF ILLUSTRATED EMBODIMENTS

An automated sample mixing and centrifuging apparatus capable of mixing the contents of one or more centrifuge sample tubes and then centrifuging the sample tubes in the same apparatus is disclosed herein. The apparatus comprises an electric slip ring, one or more mixing actuators, a device motor comprising a main shaft, a rotor, and one or more centrifuge tube buckets.

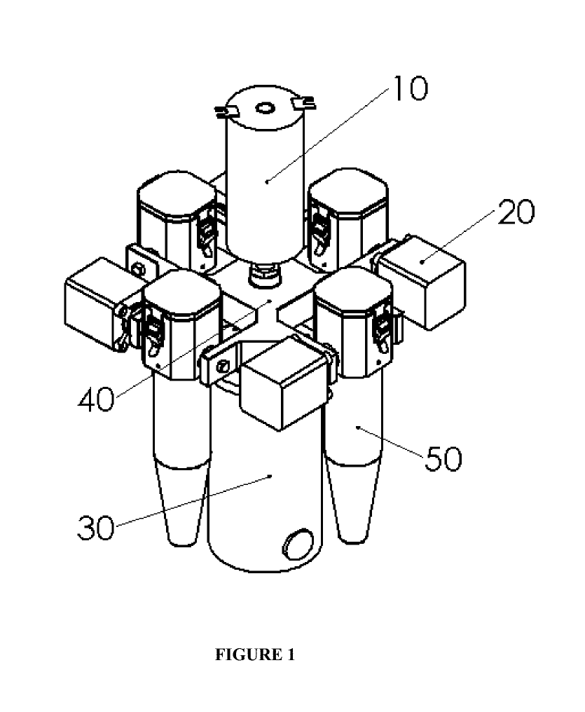

FIG. 1 illustrates an embodiment of the apparatus comprising electric slip ring 10, mixing actuator 20, device motor 30, rotor 40, and centrifuge tube bucket 50.

An electric slip ring is an electromechanical device that allows the transmission of power and signal from a stationary position to a rotating structure. In some preferred embodiments, the electric slip ring may provide power to the rotor and all electromechanical mixing actuators and electronic devices mounted to the rotor.

A mixing actuator is an electromechanical device that translates electric power into mechanical motion. In some preferred embodiments, one or more mixing actuators may cause the contents of one or more samples in one or more centrifuge tube buckets to be mixed. A mixing actuator may be a stepper motor, a servo motor, a gear motor, a DC motor, an AC motor, or any other electromechanical device capable of actuation.

In some preferred embodiments, the device motor provides the necessary power used to mechanically rotate the assembly of the rotor, mixing actuators, and electric slip ring. The device motor may be powered electrically, mechanically, or pneumatically. The device motor may be similar to motors used to power laboratory centrifuges.

A rotor is a rotating structure mounted to the device motor on which other elements of the apparatus may be mounted. The rotor may be mounted onto the main shaft of the device motor via a keyless bushing.

The electrical slip ring comprises one or more wires that transport electricity to the mixing actuators. The electrical slip ring may be mounted concentrically to the rotor through an extension of the main shaft via a shaft coupler or may alternatively be mounted to the rotor. The wires of the electrical slip ring may be secured to an optional safety enclosure via a cable carrier to prevent interference between the wires and the rotor.

In some preferred embodiments, one or more centrifuge tube buckets may be configured to hold and secure one or more centrifuge tubes during both the mixing and centrifuging steps. A centrifuge tube bucket may be mounted to a mixing actuator and the rotor. The centrifuge tube buckets may preferably be mounted to the rotor in a swinging head configuration. The swinging head configuration enables a centrifuge tube secured to a centrifuge tube bucket to swing outward during centrifugation, and the centrifuge tube is thus not held at a fixed angle with respect to the central axis of the apparatus. In some preferred embodiments, each centrifuge tube bucket may preferably be configured to hold and secure an 8 inch standardized petroleum sample tube.

Each centrifuge tube bucket may optionally be configured with a heating element that permits heating samples to a desired temperature. The electrical slip ring may preferably provide the power necessary to operate the heating elements.

In some preferred embodiments, the apparatus may operate according to the procedure described hereafter. Power and electrical signals may be sent through the electrical slip ring that is mounted onto the rotor. Power and electrical signals may be conducted to one or more mixing actuators that are mounted on the rotor. The one or more mixing actuators may be connected to one or more centrifuge tube buckets. The mixing actuators may convert an electric input into a mechanical output that may result in motion that mixes the contents of the centrifuge tubes. Each centrifuge tube bucket may hold a centrifuge tube. A device motor mounted to the rotor may rotate the assembly of the one or more mixing actuators and one or more centrifuge tube buckets to centrifuge the contents of each centrifuge tube. Mixing may occur before or after centrifugation. Mixing may preferably be carried out by inverting each centrifuge tube to mix the contents of the centrifuge tube. In some preferred embodiments, the mixing actuators may be connected to a programmable mixing controller. The programmable mixing controller may be programmed so that the inversion of each centrifuge tube occurs a set number of times or for a set period of time.

In some preferred embodiments, the apparatus may be configured to spin a standardized petroleum sample tube up to at least about 1800 rpm.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. All references cited herein are expressly incorporated by reference.

What is claimed is:

1. An automated sample mixing and centrifuging apparatus comprising an electric slip ring, one or more mixing actuators, a device motor, and a rotor, wherein the apparatus is capable of both mixing the contents of one or more centrifuge sample tubes and centrifuging the sample tubes.

2. The apparatus of claim 1 further comprising one or more centrifuge tube buckets.

3. The apparatus of claim 2 wherein the electric slip ring and the one or more mixing actuators are mounted to the rotor to generate an assembly, wherein the mixing actuators are electromechanical mixing actuators, and wherein the electric slip ring provides power to the rotor and all electromechanical mixing actuators and electronic devices mounted to the rotor.

4. The apparatus of claim 3 wherein the device motor provides the necessary power used to mechanically rotate the assembly of the rotor, mixing actuators, and electric slip ring.

5. The apparatus of claim 4 wherein the device motor comprises a main shaft and wherein the rotor is mounted onto the main shaft of the device motor via a keyless bushing.

6. The apparatus of claim 5 wherein the electrical slip ring comprises one or more wires that transports electricity to the mixing actuators and wherein the electrical slip ring is mounted concentrically to the rotor through an extension of the main shaft via a shaft coupler.

7. The apparatus of claim 6 wherein the wires of the electrical slip ring are secured to an optional safety enclosure via a cable carrier to prevent interference between the wires and the rotor.

8. The apparatus of claim 2 wherein the one or more centrifuge tube buckets are mounted to the rotor in a swinging head configuration and are configured to hold and secure one or more centrifuge tubes during both the mixing and centrifuging steps.

9. The apparatus of claim 8 wherein each centrifuge tube bucket is configured to hold and secure an 8 inch standardized petroleum sample tube.

10. The apparatus of claim 8 wherein each centrifuge tube bucket is configured with a heating element that permits heating samples to a desired temperature.

11. The apparatus of claim 9 wherein the apparatus is configured to spin a standardized petroleum sample tube up to at least about 1800 rpm.
